(19) United States
(12) Patent Application Publication
(10) Pub. No.: US 2024/0012741 A1
(43) Pub. Date: Jan. 11, 2024

(54) METHOD FOR TESTING A COMPUTER PROGRAM IN MULTIPLE COMPOSITIONS MADE UP OF COMPUTER PROGRAM MODULES

(71) Applicant: Robert Bosch GmbH, Stuttgart (DE)

(72) Inventors: Christopher Huth, Heilbronn (DE); Markus Dreher, Salem (DE)

(21) Appl. No.: 18/346,994

(22) Filed: Jul. 5, 2023

(30) Foreign Application Priority Data
Jul. 6, 2022 (DE) 10 2022 206 900.5

(51) Int. Cl. G06F 11/36

(52) U.S. Cl. CPC G06F 11/3672

(57) ABSTRACT

A method for testing a computer program in multiple compositions made up of computer program modules. The method includes carrying out multiple test runs. In each test run, a base test input is selected from a set of base test inputs that are predefined for the test run, each being a subset of computer program modules of a set of computer program modules of which the computer program may be made up, the base test input for a test input is changed as a function of the output of a random number generator. Program code of the computer program is compiled to form a version of the computer program in a composition made up of computer program modules that is given by the changed test input. The version of the computer program is tested.

### FIELD

The present description relates to a method for testing a computer program in multiple compositions made up of computer program modules.

### BACKGROUND INFORMATION

An important component of the development of software is testing and, when errors are found, appropriate error correction. In particular, errors that result in the failure of a computer program are to be identified and corrected.

However, a computer program may often be made up of many different modules (i.e., program parts). Since there may be a large number of such modules (which, for example, has increased over time), there is also a correspondingly large number of combinations and thus, configurations, of the computer program. Testing all of these requires enormous effort. Automotive standards prescribe, for example, certain development and test methods which require time-consuming work by hand and which cannot be bypassed. Depending on the application, the code base has generally grown over decades, with huge sets of legacy code, and code constructs that are difficult to maintain. The legacy code must be accepted as such, which means that adaptations cannot be made when there are changes in the run time. This complex code base is no longer manageable for humans, and therefore is typically not corrected by developers. In addition, normally there are no specifications that fully describe whether or not a pair of modules is allowed. At best, this knowledge is implicitly contained in the official specifications.

Since in particular the testing of a set of newly added configurations (for example, due to introduction or replacement of one or multiple modules) involves a high level of complexity (and high costs), software is typically tested during use. However, this does not solve the problem of possible errors, and the untested software results in risks with unforeseeable consequences.

Therefore, an approach for efficiently testing software for which various configurations (i.e., compositions made up of program parts) are possible is desirable.

### SUMMARY

According to various specific embodiments of the present invention, a method for testing a computer program in multiple compositions made up of computer program modules is provided, including carrying out multiple test runs, in each test run, a base test input being selected from a set of base test inputs that are predefined for the test run, each base test input being a subset of computer program modules of a set of computer program modules of which the computer program may be made up, the base test input for a test input being changed as a function of the output of a random number generator, program code of the computer program being compiled to form a version of the computer program in a composition made up of computer program modules that is given by the changed test input, the version of the computer program being tested, an increase in the value of a test metric that is achieved by testing the version of the computer program being ascertained, and the changed test input being added as a base test input to the set of base test inputs for subsequent test runs, as a function of the increase in the value of the test metric.

As described, fuzzing prior to the compilation instead of (or in addition to) prior to the execution is applied; i.e., the test inputs do not specify (or do not just specify) input data with which a computer program is executed, but, rather, also specify the composition of the computer program, i.e., from which program parts (i.e., from which program code sections) the computer program is compiled. This allows the efficient testing of configurations of a computer program.

Various exemplary embodiments of the present invention are stated below.

Exemplary embodiment 1 is a method for testing a computer program in multiple compositions made up of computer program modules, as described above.

Exemplary embodiment 2 is the method according to exemplary embodiment 1, the test metric being a test coverage that has been achieved by the carried out test runs of the multiple test runs.

The taking into account of a test coverage for selecting test inputs results in a high test efficiency compared to purely random testing, for example (i.e., purely random test inputs).

Exemplary embodiment 3 is a method according to exemplary embodiment 1 or 2, the changed test input indicating the composition made up of computer program modules, in that precompiler switches, macros, or inline functions in the program code are set or executed according to the changed test input.

Thus, as described, the fuzzing of inputs for a compiled computer program to be tested is expanded to inputs concerning the compiling of the program code to form the computer program (i.e., the creation of the executable computer program).

Exemplary embodiment 4 is a method according to one of exemplary embodiments 1 through 3, it being registered if for a changed base test input, the program code of the computer program cannot be compiled to form a version of the computer program in a composition made up of computer program modules that is given by the changed test input, and a search being made for a version of the computer program in a composition, made up of the fewest possible computer program modules and/or the least possible program code, that may be compiled and that is error-free.

Thus, during testing, the most lightweight configuration (executable and error-free version) of the computer program possible may be found at the same time.

Exemplary embodiment 5 is a method according to one of exemplary embodiments 1 through 4, the testing of the version of the computer program including multiple test runs using random or pseudorandom test inputs (i.e., the sequence of the generated test inputs is reproducible).

In other words, within a test run (in which a configuration of the computer program is selected), fuzzing for testing the configuration is provided. This may be regarded as hierarchical fuzzing, the external hierarchy level being situated prior to the compiling, and multiple test runs of the particular version of the computer program being carried out within each test run of the external hierarchy level. In this way, possible configurations are efficiently investigated and efficiently tested in each case.

Exemplary embodiment 6 is a test system that is configured to carry out a method according to one of exemplary embodiments 1 through 5.

Exemplary embodiment 7 is a computer program that includes commands which, when executed by a processor, prompt the processor to carry out a method according to one of exemplary embodiments 1 through 5.

Exemplary embodiment 8 is a computer-readable medium that stores commands which, when executed by a processor, prompt the processor to carry out a method according to one of exemplary embodiments 1 through 5.

In the figures, similar reference numerals generally refer to the same parts in all the various views. The figures are not necessarily true to scale, emphasis instead being placed in general on illustrating the principles of the present invention.

In the following description, various aspects are described with reference to the figures.

### BRIEF DESCRIPTION OF THE DRAWINGS

FIG. 1 shows a computer for the development and/or testing of software applications, according to an example embodiment of the present invention.

FIG. 2 illustrates the testing of various configurations of a computer program with the aid of a test system including a fuzzer that selects configurations based on observations, according to an example embodiment of the present invention.

FIG. 3 shows a flowchart illustrating a method for testing a computer program in multiple compositions made up of computer program modules according to one specific embodiment of the present invention.

### DETAILED DESCRIPTION OF EXAMPLE EMBODIMENTS

The following detailed description relates to the figures, which for explanation show particular details and aspects of this description in which the present invention may be carried out. Other aspects may be used, and structural, logical, and electrical modifications may be made, without departing from the scope of protection of the present invention. The various aspects of this description are not necessarily mutually exclusive, since some aspects of this description may be combined with one or multiple other aspects of this description to form new aspects.

Various examples are described in greater detail below.

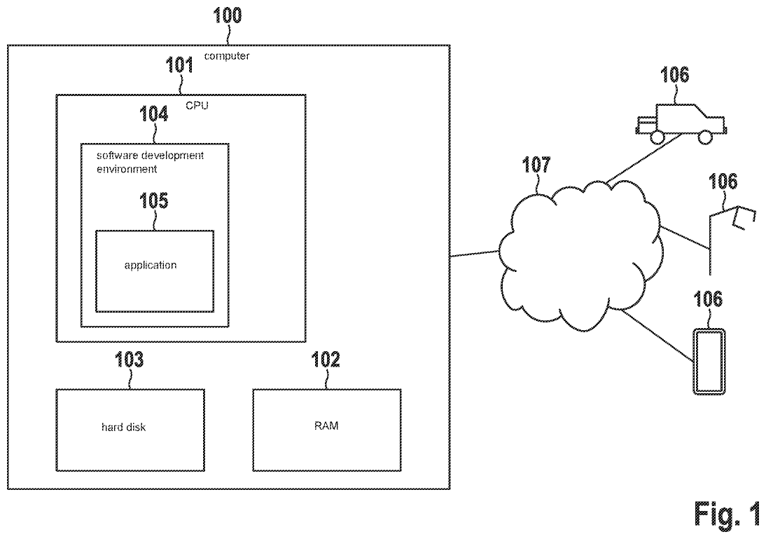

FIG. 1 shows a computer 100 for the development and/or testing of software applications.

Computer 100 includes a central processing unit (CPU) 101 and a working memory (RAM) 102. Working memory 102 is used to load program code, for example from a hard disk 103, and CPU 101 executes the program code.

In the present example, it is assumed that a user intends to use computer 100 to develop and/or test a software application.

For this purpose, the user executes a software development environment 104 on CPU 101.

Software development environment 104 allows the user to develop and test an application (i.e., a computer program, i.e., software) 105 for various devices 106, i.e., target hardware, such as embedded systems for controlling robotic devices, including robotic arms and autonomous vehicles, or also for mobile (communication) devices. For this purpose, CPU 101 as part of software development environment 104 may execute an emulator in order to simulate the behavior of particular device 106 for which an application is being or has been developed. However, the computer may also control an execution of software 105 on particular target device 106, and may thus test software 105. If it is used only for testing a software from another source, software development environment 104 may also be regarded as or designed for a software test environment (including one or multiple test programs, i.e., test tools).

The user may distribute the finished application to appropriate devices 106 via a communications network 107. This may also take place in some way other than via a communications network 107, for example with the aid of a USB stick.

However, before this takes place, the user is to test application 105 and correct errors (i.e., adapt application 105, i.e., the program, if necessary) in order to prevent an application that is not functioning properly from being distributed to devices 106. This may also be the case if the user him/herself has not written application 105 on computer 100.

One test method is so-called fuzzing. Fuzzing or fuzz testing is an automated software test method in which a computer program to be tested is supplied with invalid, unexpected, or random data as inputs. The program is then monitored for exceptions such as crashes, missing failed integrated code assertions, or potential memory leaks.

Fuzzers (i.e., test programs that use fuzzing) are typically used for testing programs that process structured inputs. This structure is specified, for example, in a file format or a file format or protocol, and distinguishes between valid and invalid inputs. An effective fuzzer generates semi-valid inputs that are “valid enough” to avoid being directly rejected by the input parser of the program to be tested, but that are “invalid enough” to cover unexpected behaviors and detect borderline cases that are not correctly handled in the program to be tested. A fuzzer may be applied, for example, to an application that communicates via freely accessible memory areas that are used by multiple applications.

Terminology used in conjunction with fuzzing is described below:
Fuzzing or fuzz testing is the automated test process of sending randomly generated inputs to a target program (program to be tested) and observing its response.
A fuzzer or a fuzzing engine is a program that automatically generates inputs. Thus, it is not linked to the software to be tested, and also no instrumentation is carried out. However, the fuzzer or a fuzzing engine has the ability to instrument code, generate test cases, and execute programs to be tested. Conventional examples are AFL and Libfuzzer.
A fuzz target is a software program or a function that is to be tested by fuzzing. A key feature of a fuzz target should be that it does not accept potentially untrustworthy inputs that are generated by the fuzzer during the fuzzing process.
A fuzz test is the combined version of a fuzzer and a fuzz target. A fuzz target may then be instrumented code in which a fuzzer is linked to its inputs (i.e., delivers them). A fuzz test is executable. A fuzzer may also start multiple fuzz tests and may observe and stop them (normally hundreds or thousands per second), each including a slightly different input that is generated by the fuzzer.
A test case is a certain input and a certain test run from a fuzz test. For reproducibility, runs of interest (finding new code paths or crashes) are normally stored. In this way, a certain test case including the corresponding input may also be executed on a fuzz target that is not connected to a fuzzer, for example the release version of a program.
Coverage-guided fuzzing uses code coverage information as feedback during the fuzzing in order to recognize whether an input has caused the execution of new code paths or blocks.
Generation-based fuzzing uses prior knowledge about the target program (fuzz target) in order to create test inputs. One example of such prior knowledge is a grammar that corresponds to the input specification of the fuzz target, i.e., the input grammar of the fuzz target (i.e., of the program to be tested).
Static instrumentation is the insertion of instructions into a program (to be tested) in order to obtain feedback about the execution. Static instrumentation is usually implemented by the compiler, and may indicate, for example, the achieved code blocks during the execution.
Dynamic instrumentation is the control of the execution of a program (to be tested) during run time in order to generate feedback from the execution. Dynamic instrumentation is usually implemented by operating system functionalities or by the use of emulators.
Mutation-based fuzzing is the generation of new inputs, using a set (corpus) of known inputs (also referred to herein as a base test inputs) by random applications of mutations thereon; i.e., new test inputs are generated by random changing of base test inputs (the set of base test inputs changing during the test, i.e., over the test runs).

For example, the fuzzers AFL, Honggfuzz, or Libfuzzer provide mutation-based, coverage-guided fuzzing for testing software with little complexity. In each pass (i.e., for each test case or test run), an input is selected from the input corpus, randomly mutated, and sent to the target program. If the newly generated input triggers a behavior not previously seen (for example, new executed code paths), it is added to the input corpus. In this way, the input space of a program 105 may be investigated with little or no knowledge of the input format of the program.

Embedded software for vehicles is generally developed for highly customer-specific hardware. This means that there may be many differently configured modules, for example bus systems, that are switched on or off as needed. Thus, over the years, so many modules have been developed for an embedded control unit (an ECU, for example) that in practice it is not possible to test all the various combinations of modules. As a result, often only a few reference configurations are defined that are completely tested, and other configurations remain untested (by the manufacturer). Conventional fuzzing runs on statically built or compiled software. Each build has its own configuration, so that in practice, conventional fuzzing cannot be used to test all the various builds (i.e., compositions of software made up of multiple program parts, referred to here as “configuration”). The fuzzing of only individual selected configurations brings little benefit.

According to various specific embodiments, in view of the above discussion a test method is provided in which a fuzzer, i.e., the test program, selects a configuration. Thus, different configurations are tested in the course of the testing, in that the test program engages prior to or during the compilation of computer program 105 to be tested; i.e., for a test case the test program generates a test input that specifies the configuration of program 105 to be tested, i.e., specifies from which components program 105 to be tested is built during the compiling of program 105 to be tested. The test method thus takes the various configurations into account. As an illustrative example, the fuzzing prior to the compiler takes place (or at least does not take place only) prior to the input interface of program 105 to be tested in a certain configuration; i.e., the test inputs generated by the fuzzer do not specify (or do not specify just) inputs for program 105 to be tested in a certain configuration, but, rather, also the configuration of program 105 to be tested for a test run. The selection of the configurations for test runs may follow various metrics (i.e., various types of feedback), for example may be coverage-guided. This allows significantly higher efficiency for a search-based task (for example, searching for errors) than purely random testing (i.e., random selection of configurations). Due to the testing of configurations during the compiling, it may be detected in particular if the compiling fails. The provided test method allows in particular the testing of automotive software including a large legacy code basis and a heterogeneous module selection.

The test software may, for example, set a configuration by using precompiler switches, macros, or inline functions that are present in the program code.

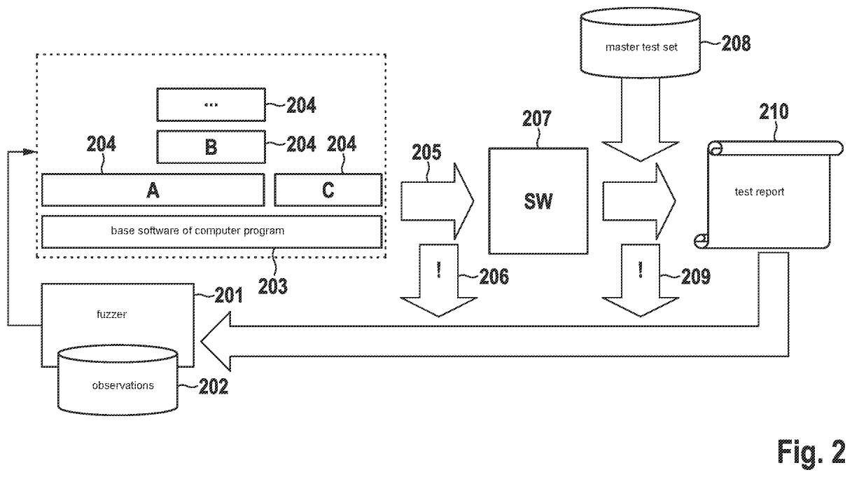

FIG. 2 illustrates the testing of various configurations of a computer program with the aid of a test system (for example, software development environment 104), using a fuzzer 201 that selects configurations based on observations.

Fuzzer 201 is first initialized; i.e., observations 202 are empty or are set to the observations of a test run of the computer program for a certain configuration (for example, given by a certain test input (for example, specified by an appropriate seed value) that, for example, sets precompiler switches, activates macros, etc., for example automatically with the aid of a script).

For each test run, fuzzer 201 selects a configuration by selecting base software of computer program 203 and various modules of a set of possible modules 204. The fuzzer makes this selection based on the observations that are present (or, for example, according to a predefined test input if no observations are yet present).

The computer program is compiled in 205 according to the selected configuration; i.e., a version of computer program (software) 207 is “built” according to the selected configuration, i.e., including linking, etc. If this fails, an appropriate test report is prepared in 206 and sent back to the fuzzer, and the test run ends.

If the compiling is successful, computer program 207 (more precisely, the version of computer program 207) is tested according to the configuration used for the present test run, using tests from a master test set 208. The master test set contains tests for all modules 204. The tests from the master test set, which are used by the test system in the particular configuration for testing computer program 207, may be selected as a function of the configuration. For example, only tests that concern modules (for example, that test same) that are present in the present configuration are used in order to avoid false-positive test results.

In addition to tests (i.e., test criteria), the master test set also contains test input data for the computer program (and, for example, reference results for the test input data). The test input data in turn may be provided by a (further) fuzzer. In particular, for computer program 207 in the selected configuration, multiple fuzzing test runs may be carried out in which the input data for computer program 207 are varied in the selected configuration.

If a test fails, i.e., if an error is detected in computer program 207, this is sent back to the fuzzer in 209.

Upon successful testing, a test report 210 including information for a test metric, such as the test coverage (for example, the achieved functions of the code, the achieved modules, the achieved paths, etc.), is sent back to the fuzzer as an observation. Test report 210 may contain not only information concerning whether a module has been tested or covered, but also values of detailed coverage metrics such as line coverage, program branch coverage, function coverage, edge coverage, etc.

Fuzzer 201 optimizes the test metric, for example attempts to make the overall coverage achieved by the test sequences as great as possible. The fuzzer sees how successful a selected configuration was, for example because it achieved or did not achieve new processing paths. Based on this assessment of configurations, the fuzzer may select a new configuration for a subsequent test run. For example, the fuzzer takes a configuration as the basis for a new configuration (mutates, for example, a test input that specifies the configuration) if the configuration was successful.

For example, initial test inputs that specify configurations already tested are provided to fuzzer 201. Fuzzer 201 may also include, as initial information, a configuration matrix that allows the fuzzer to exclude known incompatible configurations and false-positive results (for example, a sunroof is not compatible with a convertible, and therefore is not compatible with associated modules). Prior to each test session, for example (i.e., the testing of the program in multiple test runs, each with a particular configuration), the fuzzer is provided with an initial test input.

The fuzzer contains information concerning combinations of modules 204 that do not function (i.e., in which the compiling fails or in which errors occur). The fuzzer may thus learn which module combinations are problematic.

The fuzzer may also select configurations with the objective of finding a minimally functional (in particular compilable) configuration. This may avoid the situation that problematic modules (i.e., those with errors) are not detected because they are concealed by other modules (for example, not executed because the data processing is carried out in a different module).

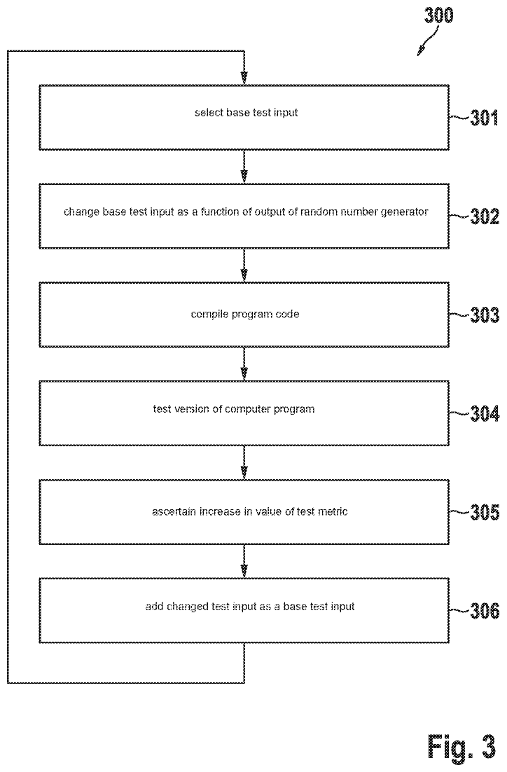

In summary, according to various specific embodiments a method is provided as illustrated in FIG. 3.

FIG. 3 shows a flowchart 300 that illustrates a method for testing a computer program in multiple compositions made up of computer program modules according to one specific embodiment.

Multiple test runs are carried out, in each test run
a base test input being selected in 301 from a set of base test inputs that are predefined for the test run, each base test input being a subset of computer program modules of a set of computer program modules of which the computer program may be made up,
the base test input for a test input being changed in 302 as a function of the output of a random number generator,
program code of the computer program being compiled in 303 to form a version of the computer program in a composition made up of computer program modules that is given by the changed test input,
the version of the computer program being tested in 304,
an increase in the value of a test metric that is achieved by the testing of the version of the computer program being ascertained in 305, and
the changed test input being added in 306 as a base test input to the set of base test inputs for subsequent test runs, as a function of the increase in the value of the test metric.

For example, the changed test input is added as a base test input to the set of base test inputs for subsequent test runs when an increase in the value of the test metric (coverage, for example) is above a predefined threshold (such as for mutation-based fuzzing, for example), for example when a new processing path or a new module, etc., which was not yet detected during the previous test runs has been detected during the test.

Test metrics may also aim at nonfunctional tests, for example from differential fuzzing. One example here would be the test metric execution time, for example to find configurations that exceed a time limit. Another example is memory usage to find configurations that exceed a memory limit and reserve too much memory. A changed test input would then be added to the set of base test inputs for subsequent test runs if it has resulted in a configuration with a particularly long execution time (not previously reached, for example) or in a configuration with a particularly large memory area (not previously reached, for example).

The base test input is randomly changed, in the sense that the change is a function of the output of a random number generator.

A set of functional tests which must at least be run through, and a further set of optional tests for certain features, may also be provided.

It should be noted that the compiling of the computer program to form a version of the computer program in a composition made up of computer program modules that is given by the changed test input may contain tasks such as linking that are necessary for the version of the computer program to be executable.

It should be noted that various compositions of computer program modules, i.e., various combinations of computer program modules, may be referred to as different versions of the (same) computer program. The term “computer program” thus encompasses the computer program in all possible compositions (which are referred to as “versions”).

The method from FIG. 3 may be carried out by a test system that includes one or multiple computers including one or multiple data processing units. The term “data processing unit” may be understood as any type of entity that enables the processing of data or signals. The data or signals may be treated, for example, according to at least one (i.e., one or more than one) particular function that is carried out by the data processing unit. A data processing unit may include an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination of same or may be formed from same. Any other way of implementing the particular functions, described in greater detail herein, may also be understood as a data processing unit or logic circuit system. One or multiple of the method steps described in detail here may be carried out (implemented, for example) by a data processing unit via one or multiple particular functions that are carried out by the data processing unit.

Although particular specific embodiments have been illustrated and described here, it is recognized by those skilled in the art in the field that the particular specific embodiments shown and described may be exchanged with numerous alternative and/or equivalent implementations without departing from the scope of protection of the present invention. The present patent application is intended to encompass any adaptations or variations of the particular specific embodiments discussed here.

1-8. (canceled)

9. A method for testing a computer program in multiple compositions made up of computer program modules, including:
carrying out multiple test runs, in each test run of the multiple test runs:
selecting a base test input from a set of base test inputs that are predefined for the test run, each base test input being a subset of computer program modules of a set of computer program modules of which the computer program may be made up;
changing the base test input for a test input as a function of an output of a random number generator;
compiling program code of the computer program to form a version of the computer program in a composition made up of computer program modules that is given by the changed test input;
testing the version of the computer program;
ascertaining an increase in the value of a test metric that is achieved by testing the version of the computer program; and
adding the changed test input as a base test input to the set of base test inputs for subsequent test runs, as a function of an increase in the value of the test metric.

10. The method as recited in claim 9, wherein the test metric is a test coverage that has been achieved by the carried out test runs of the multiple test runs.

11. The method as recited in claim 9, wherein the changed test input indicates the composition made up of computer program modules, in that precompiler switches or macros or inline functions in the program code are set or executed according to the changed test input.

12. The method as recited in claim 9, wherein it is registered if for a changed base test input, the program code of the computer program cannot be compiled to form a version of the computer program in a composition made up of computer program modules that is given by the changed test input, and a search is made for a version of the computer program in a composition, made up of the fewest possible computer program modules and/or the least possible program code, that may be compiled and that is error-free.

13. The method as recited in claim 9, wherein the testing of the version of the computer program includes multiple test runs using random or pseudorandom test inputs.

14. A test system configured to test a computer program in multiple compositions made up of computer program modules, the system configured to:
carry out multiple test runs, in each test run of the multiple test runs:
select a base test input from a set of base test inputs that are predefined for the test run, each base test input being a subset of computer program modules of a set of computer program modules of which the computer program may be made up;
change the base test input for a test input as a function of an output of a random number generator;
compile program code of the computer program to form a version of the computer program in a composition made up of computer program modules that is given by the changed test input;
test the version of the computer program;
ascertain an increase in the value of a test metric that is achieved by testing the version of the computer program; and
add the changed test input as a base test input to the set of base test inputs for subsequent test runs, as a function of an increase in the value of the test metric.

15. A non-transitory computer-readable medium on which is stored a computer program including commands for testing a computer program in multiple compositions made up of computer program modules, the commands, when executed by a computer, causing the computer to perform the following steps:
carrying out multiple test runs, in each test run of the multiple test runs:
selecting a base test input from a set of base test inputs that are predefined for the test run, each base test input being a subset of computer program modules of a set of computer program modules of which the computer program may be made up;
changing the base test input for a test input as a function of an output of a random number generator;
compiling program code of the computer program to form a version of the computer program in a composition made up of computer program modules that is given by the changed test input;
testing the version of the computer program;
ascertaining an increase in the value of a test metric that is achieved by testing the version of the computer program; and
adding the changed test input as a base test input to the set of base test inputs for subsequent test runs, as a function of an increase in the value of the test metric.
